(19) United States
(12) Patent Application Publication
(10) Pub. No.: US 2015/0093654 A1
(43) Pub. Date: Apr. 2, 2015

(54) COMPOSITION FOR A LITHIUM BATTERY COMPRISING AT LEAST ONE SPECIFIC FLUORINATED COMPOUND AS AN ORGANIC SOLVENT AND AT LEAST ONE LITHIUM SALT

(71) Applicant: COMMISSARIAT À L'ÉNERGIE ATOMIQUE ET AUX ÉNERGIES ALTERNATIVES, Paris (FR)

(72) Inventors: Hervé Galiano, La Ville Aux Dames (FR); Charlotte Beord, Saint Avertin (FR); Nathalie Pierre, Monts (FR); Stéphane Cadra, Saint Avertin (FR); Bruno Ameduri, Montpellier (FR); Ali Alaaeddine, Majdal Silim (LB); Noureddine Ajellal, Helsinki (FI)

(73) Assignee: COMMISSARIAT À L'ÉNERGIE ATOMIQUE ET AUX ÉNERGIES ALTERNATIVES, Paris (FR)

(21) Appl. No.: 14/394,559

(22) PCT Filed: Apr. 19, 2013
(86) PCT No.: PCT/EP2013/058190

§ 371 Date: Oct. 15, 2014

(30) Foreign Application Priority Data
Apr. 23, 2012 (FR) 1253711

(51) Int. Cl. H01M 10/0569

(52) U.S. Cl. CPC H01M 10/0569
USPC 429/341; 558/204; 558/188

(57) ABSTRACT

The invention relates to compositions comprising at least one fluorinated compound of the following formula (I):

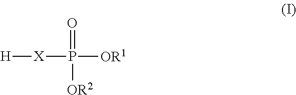

wherein:
X corresponds to a unit of the following formula (II):

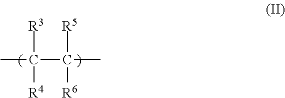

or to a sequence of said unit of formula (II),
wherein R³, R⁴, R⁵ et R⁶ represent, independently of each other, a halogen atom, a hydrogen atom, a perfluoroalkoxy group, a perfluoroalkyl group provided that at least one of said R³, R⁴, R⁵ et R⁶ represents a fluorine atom, a perfluoroalkoxy group or a perfluoroalkyl group;
R¹ and R² represents, independently of each other, an alkyl group; and
comprising at least one lithium salt.

### TECHNICAL FIELD

The present invention relates to compositions in particular intended to be used as an electrolyte conducting lithium ions in lithium batteries, said compositions comprising at least one specific fluorinated compound and at least one lithium salt, said fluorinated compound may fulfill the function of a solvent in particular capable of allowing dissolution of lithium salt.

Thus, it is therefore quite naturally that these compositions may find application in the field of electrolytes, and notably electrolytes intended to enter the structure of lithium batteries.

Lithium batteries are of particular interest for fields where self-sufficiency is a primordial criterion, as this is the case of the field of computer science, video, mobile telephony, transportation such as electric vehicles, hybrid vehicles or further medical, space, microelectronics field.

From a functional point of view, lithium batteries are based on the principle of intercalation-deintercalation of lithium within constitutive materials of the electrodes of the electrochemical cells of the battery.

More specifically, the reaction at the origin of the production of current (i.e. when the battery is in a discharge mode) sets into play the transfer, via an electrolyte conducting lithium ions, of lithium cations from a negative electrode which will be inserted into the acceptor lattice of the positive electrode, while electrons from the reaction at the negative electrode will supply the external circuit, to which are connected the positive and negative electrodes.

These electrolytes may consist in a mixture comprising at least one organic solvent and at least one lithium salt for ensuring the conduction of said lithium ions, which requires that the lithium salt be dissolved in said organic solvent.

Presently, the organic solvents used for ensuring this function are conventionally carbonate solvents, such as ethylene carbonate, dimethyl carbonate, diethyl carbonate.

The inventors of the present invention have proposed to apply novel compositions intended to be used as electrolytes for lithium batteries, comprising at least one compound which has the following characteristics:
capability of easily dissolving lithium salts;
good electrochemical stability;
good thermal and chemical inertia; and
capability of reducing the flammability of the electrolyte, into which they are incorporated.

### DISCUSSION OF THE INVENTION

Thus, the invention relates to a composition comprising:
at least one fluorinated compound of the following formula (I):

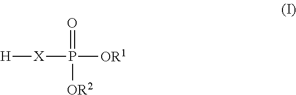

wherein:
   X corresponds to a unit with the following formula (II):

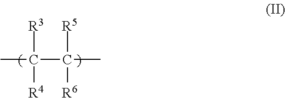

or to a sequence of said unit of formula (II),
wherein R³, R⁴, R⁵ et R⁶ represent, independently of each other, a halogen atom, a hydrogen atom, a perfluoroalkoxy group or a perfluoroalkyl group, provided that at least one of said R³, R⁴, R⁵ and R⁶ represent a fluorine atom, a perfluoroalkoxy group or a perfluoroalkyl group;
   R¹, R², represent, independently of each other, an alkyl group; and
   at least one lithium salt.

Before going into more details in the description, we specify the following definitions.

By alkyl group, is conventionally meant in the foregoing and in the following, a linear or branched alkyl group of formula —CₙH₂ₙ₊₁, n corresponding to the number of carbon atoms, this number may range from 1 to 5. In particular, it may be a methyl group.

By perfluoroalkoxy group, is conventionally meant, in the foregoing and in the following, an-O-alkyl group, in which all the hydrogen atoms are replaced with fluorine atoms, this group fitting the formula —O—CₙF₂ₙ₊₁, n corresponding to the number of carbon atoms, this number may range from 1 to 3. In particular, this may be a perfluoromethoxy group —OCF₃.

By perfluoroalkyl group, is conventionally meant in the foregoing and in the following, a linear or branched alkyl group of formula —CₙF₂ₙ₊₁, n corresponding to the number of carbon atoms, this number may range from 1 to 5. In particular, this may be a perfluoromethyl group.

By sequence of said units of formula (II), is meant the fact that said unit is repeated several times so as to form a group forming a bridge between the hydrogen atom and the group —P(O)(OR¹)(OR²), said group forming a bridge may thus be illustrated in the following formula (III):

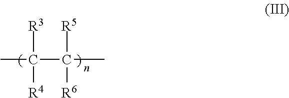

n corresponding to the number of repetitions of the unit taken between brackets, n being an integer greater than 1.

In order to avoid any ambiguity, we finally specify, more explicitly that:
when X corresponds to a unit of formula (II), the compounds of the invention may be illustrated by the following chemical formula (IV):

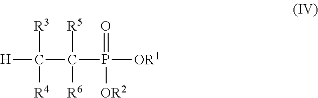

when X corresponds to a sequence of said unit of formula (II), the compounds of the invention may be illustrated by the following chemical formula (V):

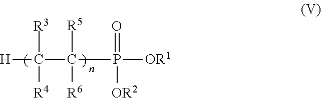

n corresponding to the number of repetitions of the unit taken between brackets, and being greater than 1, for example which may range up to 10.

According to a first particular embodiment, at least one of the groups R³ to R⁶ is a fluorine atom or a perfluoroalkyl group and at least one of the groups R³ to R⁶ is a hydrogen atom.

Thus, for example, R³ and R⁴ may represent a fluorine atom, while R⁵ and R⁶ may represent a hydrogen atom.

Compounds complying with the inventions and fitting this definition may be compounds of the following formula (VI):

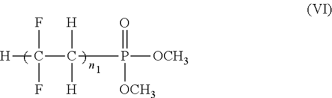

wherein n₁ corresponds to the number of repetitions of the unit taken between brackets, which is an integer greater than or equal to 1.

In particular, n₁ may be an integer equal to 1 or 2. When n₁ is an integer greater than 1 and less than 30, this compound may be described as a telomer.

According to another example, always according to this first embodiment, R⁵, R⁶ and R³ may represent a hydrogen atom and R⁴ a perfluoroalkyl group, such as a perfluoromethyl group.

According to a second particular embodiment of the invention, at least one of the groups R³ to R⁶ is a fluorine atom and at least one of the groups R³ to R⁶ is a perfluoroalkoxy group, a perfluoroalkyl group or a halogen other than a fluorine atom.

Thus, for example, R³, R⁵ and R⁶ may represent a fluorine atom and R⁴ may represent a perfluoroalkoxy group, such as perfluoromethoxy group.

Compounds complying with the invention and fitting this definition may be compounds of the following formula (VII):

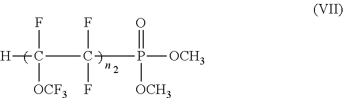

wherein n₂ corresponds to the number of repetitions of the unit taken between brackets, which is an integer greater than or equal to 1.

In particular, n₂ may be an integer equal to 1 or 2.

When n₂ is an integer greater than 1 and less than 30, this compound may be described as a telomer compound.

Said compounds of formulae (VII) may also coexist in a mixture with isomer compounds of the following formula (VIII):

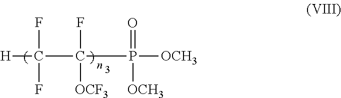

wherein n₃ corresponds to the number of repetitions of the unit taken between brackets which is an integer greater than or equal to 1.

According to other examples, always according to the second embodiment:
R³, R⁵ and R⁶ may represent a fluorine atom and R⁴ a perfluoroalkyl group, such as perfluoromethyl group; or
R³, R⁵ and R⁶ may represent a fluorine atom and R⁴ a chlorine atom.

The fluorinated compounds intended to enter the structure of the compositions of the invention may be prepared by applying a method comprising a step for putting into contact, in the presence of a free radical initiator, a monomer of the following formula (IX):

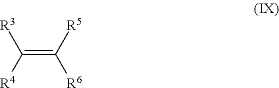

and a dialkylphosphite compound of the following formula (X):

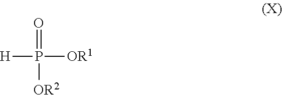

wherein R¹ to R⁶ are as defined above.

An effective free radical initiator within the scope of this method may be selected from peroxide derivatives, such as di-tert-butylperoxide, benzoyl peroxide, tert-butyl peroxide, hydrogen 2,5-di-tert-butyl-dimethyl-peroxide.

The free radical initiator may also be selected from persulfate derivatives, percarbonate derivatives, peroxydicarbonates.

The contacting step is carried out, preferably in the presence of an aprotic polar solvent, which may be selected from the following solvents:
dimethylformamide (symbolized by the acronym DMF);
acetonitrile;
cyclohexane;
a halogenated solvent, such as 1,1,2-trifluoro-1,2,2-trichloroethane, 1,1,1,3,3-pentafluorobutane, perfluorohexane, perfluoroheptane, perfluorobenzene, perfluoro-1-butyltetrahydrofurane;
tetrahydrofurane;
butyronitrile;
N-methyl-2-pyrrolidone;
dimethyl carbonate; and
mixtures thereof.

In the case when the monomer(s) appear(s) in a gaseous form (which is notably the case when the monomer is vinylidene fluoride or a fluorinated C₃ olefin) and when the contacting step is carried out under pressure, the latter may be applied in an autoclave.

For the monomers of the aforementioned formula (IX), according to a first case, at least one of the groups R³ to R⁶ is a fluorine atom or a perfluoroalkyl group and at least one of the groups R³ to R⁶ is a hydrogen atom.

Thus, for example, R³ and R⁴ may represent a fluorine atom, while R⁵ and R⁶ may represent a hydrogen atom, in which case the monomer is a vinylidene fluoride (known under the acronym of VDF).

Thus, for example R³, R⁵ and R⁶ may represent a hydrogen atom, while R⁴ may represent a perfluoroalkyl group, such as a perfluoromethyl group.

For the monomers of the aforementioned formula (IX), according to a second case, at least one of the groups R³ to R⁶ is a fluorine atom and at least one of the groups R³ to R⁶ is a perfluoroalkoxy group, a perfluoroalkyl group or a halogen atom other than a fluorine atom.

Thus, for example, R³, R⁵ and R⁶ may represent a fluorine atom and R⁴ may represent a perfluoroalkoxy group, such as a perfluoromethoxy group, in which case the monomer is perfluoromethylvinylether (known under the acronym of PMVE).

For example R³, R⁵ and R⁶ may represent a fluorine atom and R⁴ may represent a perfluoroalkyl group, such as a perfluoromethyl group, in which case the monomer is hexafluoropropene (known under the acronym of HFP).

For example R³, R⁵ and R⁶ may represent a fluorine atom and R⁴ may represent a chlorine atom, in which case the monomer is chlorotrifluoroethylene (known under the acronym of CTFE).

For the phosphite compounds of the following formula (X), R¹ and R² may correspond to a methyl group, in which case the compound is dimethyl phosphite (also called dimethyl hydrogenophosphonate).

After the contacting step, the method may comprise a step for isolating the compound from the reaction medium; this isolation step may consist in fractionated distillation of the reaction mixture.

The compounds of formula (I) have among other properties, good capability of solubilizing lithium salts.

Quite naturally, they find their application as an organic solvent for at least one lithium salt, this organic solvent entering the structure of the compositions of the invention which may thus be an electrolyte conducting lithium ions.

Thus, the invention also relates to:
the use of a fluorinated compound as defined above as an organic solvent for at least one lithium salt;
a lithium battery comprising at least one electrochemical cell comprising an electrolyte as defined above, positioned between a positive electrode and a negative electrode.

As examples, the lithium salt may be selected from the group formed by LiPF₆, LiClO₄, LiBF₄, LiA₅F₆, LiCF₃SO₃, LiN(CF₃SO₂)₃, LiN(C₂F₅SO₂), lithium bistrifluoro-methylsulfonylimide (known under the acronym of LiTFSI) LiN[SO₂CF₃]₂ and mixtures thereof.

In the lithium battery, the aforementioned liquid electrolyte may be led, in electrochemical cells of lithium batteries, to impregnate a separator, which is positioned between the positive electrode and the negative electrode of the electrochemical cell.

This separator may be in a porous material, such as a polymeric material, capable of receiving the liquid electrolyte in its porosity.

By positive electrode is conventionally meant in the foregoing and in the following, the electrode which acts as a cathode, when the generator outputs current (i.e. when it is in a discharge process) and which acts as an anode when the generator is a charging process.

By negative electrode is conventionally meant in the foregoing and in the following, the electrode which acts as an anode, when the generator outputs current (i.e. when it is in a discharge process) and which acts as a cathode when the generator is in a charging process.

Generally, the negative electrode may be based on a carbonaceous material such as graphite, and is the center of a lithium intercalation reaction, in a charging process.

The positive electrode, as for it, may be based on a lithiated transition metal oxide (the metal may, for example, be cobalt, nickel, manganese) and is the center of a lithium deintercalation reaction in a charging process.

Among the compound of formula (I) entering the structures of the compositions of the invention, some of them are novel and are the subject of the invention, said compounds are specific compounds of the following formula (I):

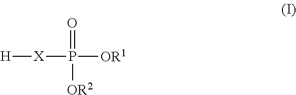

wherein:

X corresponds to a unit of the following formula (II):

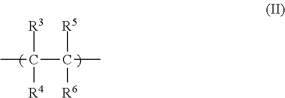

or to a sequence of said unit (II),
wherein:

R³, R⁵ and R⁶ represent a fluorine atom and R⁴ represents a perfluoroalkoxy group;
R¹ and R² represent, independently of each other, an alkyl group.

Specific compounds entering the scope of the definition above are those fitting the formula (VII) above, and more specifically with n₂ being an integer equal to 1 or 2.

The invention will now be described, with reference to the following examples, given as an indication and not as a limitation.

### DETAILED DISCUSSION OF PARTICULAR EMBODIMENTS

### Example 1

The example which follows illustrates the preparation of a fluorinated compound according to the following reaction scheme:

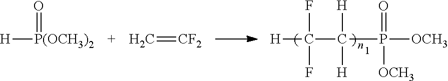

n₁ corresponding to the number of repetitions of the unit taken between brackets.

In the following examples the following reagents were used:
dimethyl phosphite, which is a commercial technical solution provided by Aldrich (98%);
di-tert-butyl peroxyde, which was provided by a Akzo;
vinylidene fluoride, which was provided by Solvay;
acetonitrile, which is a commercial technical solution (98%), distilled before use on CaH₂.

The aforementioned reaction is carried out in a 600 mL Parr Hastelloy autoclave equipped with a pressure gage, a rupture disc and output valves. A regulated device gives the possibility of controlling both the stirring and the heating of the autoclave.

Before the reaction, the autoclave is pressurized to 30 bars of nitrogen for 1 hour in order to check the seal of the latter.

Once the nitrogen is discharged, the autoclave is placed in vacuo for 40 minutes, and then dimethyl phosphite (176 g; 1.56 mol), di-tert-butyl peroxide (1.17 g) and acetonitrile (80 g) are introduced therein. Before introducing the vinylidene fluoride, the autoclave is cooled to −55° C. with an acetone/liquid nitrogen mixture. At −55° C., the reactor is tared and connected to the supply pipe of vinylidene fluoride. The vinylidene fluoride is introduced by double weighing (47 g, 0.734 mol), i.e. by estimating the mass difference before and after filling the autoclave with vinylidene fluoride. The autoclave is then weighed, which allows measurement of the exact amount of the vinylidene fluoride introduced. The autoclave is maintained heated up to 140° C. and the development of pressure and temperature was recorded. At 140° C., the pressure is around 26 bars and 1H30 after the beginning of the reaction, at 140° C., the pressure has passed from de 26 bars to 3 bars. The reaction is stopped after 5 hours and the autoclave is placed in an ice bath.

The autoclave is degassed, in order to release the vinylidene fluoride which has not reacted.

The conversion rate of vinylidene fluoride was determined by double weighing (44 g, 94%).

Next, the crude reaction mixture is distilled in vacuo (0.1-0.007 mbar), which gives the possibility of isolating:
a fraction corresponding to a compound of the following formula (XI):

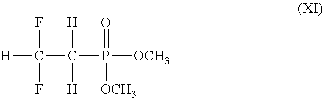

this compound being a mono-adduct corresponding to dimethyl 2,2-difluoroethylphosphonate;
a fraction corresponding to a compound of the following formula (XII):

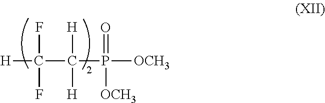

this compound being a di-adduct corresponding to dimethyl 2,2,4,4-tetrafluorobutylphosphonate;
a fraction corresponding to a mixture of the compounds of formulae (XI) and (XII).

The compound of formula (XI) was recovered in an amount of 41 g (i.e. 69% yield), has a boiling point of 42-44° C. (at 0.03 mbars) and an aspect of a colorless liquid.

It was respectively analyzed with ¹H NMR, ¹³C NMR, ³¹P NMR or GC/MS (gas chromatography coupled with mass spectrometry).

The ¹H NMR spectrum (CDCl₃, 20° C.) of the compound of formula (X) shows three signals:
a triplet (²J_{HF}=50 Hz) of multiplets centered at 6.05 ppm assigned to the hydrogen atom of the difluoromethyl terminal group HCF₂;
doublets of multiplets located at 3.75 ppm assigned to the hydrogens of the two methyl groups of the phosphonate function;
a complex system located at 2.4 ppm assigned to the hydrogens of the central methylene group related to the coupling with the phosphorus and fluorine atoms.

¹³P NMR spectrum (CDCl₃, 20° C.) shows a single signal at 23 ppm in a form of a triplet with a coupling constant ²J_{PF}=30 Hz.

¹⁹F NMR spectrum (CDCl₃, 20° C.) has a single signal at −110.2 ppm in the form of a doublet of doublets ²J_{FH}=49.5 Hz with a coupling constant ²J_{FH}=22 Hz.

The compound was also analyzed by gas chromatography coupled with mass spectrometry, which confirms the structure of the mono-adduct and allows determination of the molar mass 174 g/mol.

The compound of formula (XII) was recovered in an amount of 14.5 g (i.e. 25% yield), has a boiling point 54-56° C. (at 0.03 mbars) and an aspect of a slightly viscous colorless liquid.

It was respectively analyzed with ¹H NMR, ¹³C NMR and ³¹P NMR and in GC/MS.

The ¹H NMR spectrum (CDCl₃, 20° C.) of the compound of formula (X) has three signals:
a triplet of multiplets centered at 6.0 ppm with a coupling constant ²J_{HF}=55.3 Hz assigned to the hydrogen of the difluoromethyl terminal group HCF₂;
a doublet of multiplets located at 3.75 ppm assigned to the hydrogens of the two methyl groups of the phosphonate function;
a doublet of a quadruplet located to 2.5 ppm with a coupling constant ³J_{HF}=19.7 Hz assigned to the hydrogens of the methylene groups —CH₂.

The ³¹P NMR spectrum (CDCl₂, 20° C.) has a single signal at 22 ppm in the form of a triplet with a coupling constant ³J_{PF}=30 Hz.

The ¹⁹F NMR spectrum (CDCl₂, 20° C.) has two signals:
a signal at −115 ppm in the form of a triplet corresponding to the fluorine atom of the HCF₂;
a signal at −86.55 ppm in a form of a doublet of triplets which may be assigned to the fluorine atoms of the group —CF₂— positioned between the two methylene groups.

The compound is also analyzed by gas chromatography coupled with mass spectrometry which confirms the structure of the di-adduct and allows determination of the molar weight 238 g/mol.

### Example 2

The example which follows, illustrates the preparation of a fluorinated compound according to the following reaction scheme:

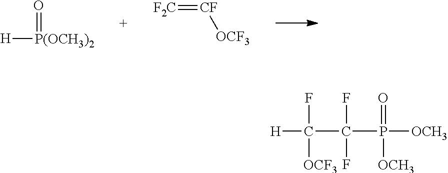

In the following examples, the following reagents were used:
dimethyl phosphite, which is a commercial technical solution provided by Aldrich (98%);
di-tert-butyl peroxide, which was provided by Akzo;
perfluoromethylvinylether (known under the acronym of PMVE), which was provided by Appolo;
acetonitrile, which is a commercial technical solution (98%), distilled before use on CaH₂.

The aforementioned reaction is carried out in a 300 mL Parr Hastelloy autoclave equipped with a pressure gage, a rupture disc and valves for introducing gas and for salting out. A regulated device gives the possibility of controlling both stirring and heating of the autoclave.

Before the reaction, the autoclave is pressurized to 30 bars of nitrogen for 1 hour in order to check the seal of the latter.

Once the nitrogen is discharged, the autoclave is placed in vacuo for 40 minutes, and then the dimethyl phosphite (36.44 g, 0.0331 mol), di-tert-butyl peroxide (4.61 g, 0.0361 mmol) and acetonitrile (80 g) are introduced therein. Before introducing the PMVE, the autoclave is cooled to −20° C. with an acetone/liquid nitrogen mixture. The PMVE is introduced by double weighing (50 g, 0.301 mol), i.e. by estimating the mass difference before and after filling the autoclave with PMVE. The autoclave is gradually heated up to 140° C. and the development of the pressure and of the temperature was recorded. During the reaction, an increase in the pressure inside the autoclave is observed due to the exothermic nature of the reaction and then a decrease of the latter, caused by the transformation of the PMVE into the desired compound. At 140° C., the pressure is close to 21 bars and one hour after the beginning of the reaction, at 140° C., the pressure has passed from 21 bars to 11 bars with a temperature maintained at 140° C. After reaction and cooling, the autoclave is left in an ice bath for 30 minutes and then degassed.

The conversion of the PMVE is determined by calculating the ration m−δm/m, wherein m and δm respectively designate the initial mass of PMVE and the mass difference before and after degassing (δm=0 meaning that the conversion rate of the PMVE is 100%).

The autoclave is degassed, in order to release the PMVE which has not reacted.

The conversion rate of the PMVE was determined by doubled weighing (42.5 g, 85%).

Next, the crude reaction mixture is distilled in vacuo (0.03 mbar), which allows isolation of different fractions. A second distillation of the obtained product is carried out in order to isolate the desired compound (colorless liquid), which is then characterized by NMR spectroscopic techniques.

The ¹H NMR, ¹⁹F NMR and ³¹P NMR spectra clearly show the presence of two isomers:
a majority isomer (at 85%) corresponding to dimethyl (3-oxa-1,1,2,4,4,4-hexafluorobutyl)phosphonate of the following formula (XIII):

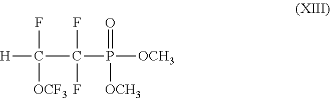 [SMILES: COP(=O)(OC)C(F)(F)C(F)OC(F)(F)F]

a minority isomer (15%) corresponding to dimethyl (1,2,2-trifluoro)-1-(trifluoromethoxyethyl)phosphonate of the following formula (XIV):

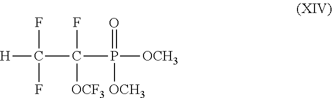 [SMILES: COP(=O)(OC)C(F)(OC(F)(F)F)C(F)F]

The mixture of the two isomers is recovered in an amount of 28 g, has a boiling temperature of 44-46° C. (at 0.03 mbars) and has an aspect of a colorless liquid.

1. Composition comprising:
at least one fluorinated compound of the following formula (I): 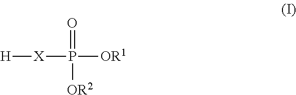
wherein:
X corresponds to a unit of the following formula (II): 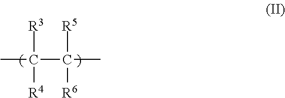
or to a sequence of said unit of formula (II),
wherein R³, R⁴, R⁵ and R⁶ represent, independently of each other, a halogen atom, a hydrogen atom, a perfluoroalkoxy group, a perfluoroalkyl group provided that at least one of said R³, R⁴, R⁵ and R⁶ represents a fluorine atom, a perfluoroalkoxy group or a perfluoroalkyl group;
R¹ and R² represents, independently of each other, an alkyl group; and
at least one lithium salt.

2. The composition according to claim 1, wherein at least one of the groups R³ to R⁶ is a fluorine atom or a perfluoroalkyl group and at least one of the groups R³ to R⁶ is a hydrogen atom.

3. The composition according to claim 1, wherein R³ and R⁴ represent a fluorine atom, while R⁵ and R⁶ represent a hydrogen atom.

4. The composition according to claim 1, wherein the fluorinated compound fits the following formula (VI): 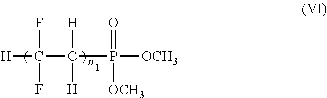
wherein n₁ corresponds to the number of repetitions of the unit taken between brackets, which is an integer greater than or equal to 1.

5. The composition according to claim 4, wherein n₁ is an integer equal to 1 or 2.

6. The composition according to claim 1, wherein at least one of the groups R³ to R⁶ is a fluorine atom and at least one of the groups R³ to R⁶ is a perfluoroalkoxy group, a perfluoroalkyl group or a halogen atom other than fluorine.

7. The composition according to claim 6, wherein R³, R⁵ and R⁶ represent a fluorine atom and R⁴ represents a perfluoroalkoxy group.

8. The composition according to claim 7, wherein the fluorinated compound fits the following formula (VII): 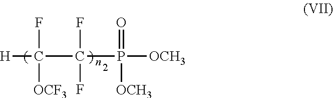
wherein n₂ corresponds to the number of repetitions of the unit taken between brackets, which is an integer greater or equal to 1.

9. The composition according to claim 8, wherein n₂ is an integer equal to 1 or 2.

10. The composition according to claim 1, which is an electrolyte conducting lithium ions.

11. A lithium battery comprising at least one electrochemical cell comprising an electrolyte as defined in claim 10, positioned between a positive electrode and a negative electrode.

12. A method of preparing an electrolyte for a lithium battery comprising dissolving at least one lithium salt in a compound as defined in claim 1.

13. A compound of the following formula (I): 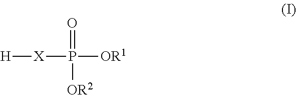
wherein
X corresponds to a unit of the following formula (II): 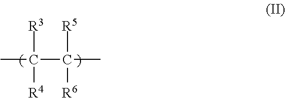
or to a sequence of said unit of formula (II),
for which:
R³, R⁵ and R⁶ represent a fluorine atom and R⁴ represents a perfluoroalkoxy group;
R¹ and R² represent, independently of each other, an alkyl group.

14. The compound according to claim 13, wherein the fluorinated compound fits the following formula (VII): 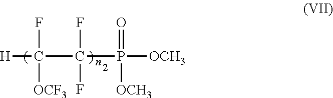
wherein n₂ corresponds to the number of repetitions of the unit taken between brackets, which is an integer greater than or equal to 1.

15. The compound according to claim 14, wherein n₂ is an integer equal to 1 or 2.
